(19) United States
(12) Patent Application Publication
(10) Pub. No.: US 2013/0250141 A1
(43) Pub. Date: Sep. 26, 2013

(54) TERMINAL DEVICE, IMAGE DISPLAYING METHOD AND IMAGE DISPLAYING PROGRAM EXECUTED BY TERMINAL DEVICE

(71) Applicants: Kenji Nakamura, Saitama (JP); Yuki Nakai, Saitama (JP)

(72) Inventors: Kenji Nakamura, Saitama (JP); Yuki Nakai, Saitama (JP)

(73) Assignee: PIONEER CORPORATION, Kanagawa (JP)

(21) Appl. No.: 13/880,870

(22) PCT Filed: Oct. 22, 2010
(86) PCT No.: PCT/JP2010/068711

§ 371 Date: May 20, 2013

(51) Int. Cl. H04N 5/225

(52) U.S. Cl. CPC H04N 5/2252
USPC 348/231.7

(57) ABSTRACT

This terminal device, which is removable from/attachable to a holding device attached to a mobile body, is provided with: an imaging means; a recording means that records captured images captured by the imaging means in the state of the terminal device being attached to the holding device; an adjustment image generating means that generates an image for adjustment that is for adjusting the imaging direction of the imaging means on the basis of a captured image recorded by the recording means; and a display control means that displays the adjustment image generated by the adjustment image generating means in a manner so as to be comparable to the captured image captured by the imaging means. As a result, the user can easily adjust the imaging direction by referring to the screen at which the adjustment image is displayed.

A terminal device which is attachable to and removable from a holding device mounted on a movable body, includes: an image capturing unit; a storage unit which stores a captured image captured by the image capturing unit in such a state that the terminal device is attached to the holding device; an adjustment image generating unit which generates an adjustment image for adjusting an image capturing direction of the image capturing unit based on the captured image stored in the storage unit; and a display controlling unit which displays the adjustment image generated by the adjustment image generating unit in a manner mutually comparable to the captured image captured by the image capturing unit. Therefore, the user can easily adjust the image capturing direction, by referring to a screen on which the adjustment image is displayed.

### TECHNICAL FIELD

The present invention relates to terminal device which is installed in a movable body and which has an image capturing means for capturing image outside the movable body.

### BACKGROUND TECHNIQUE

This kind of technique is proposed in Patent Reference-1, for example. In Patent Reference-1, there is proposed a technique for preliminarily storing a position where a rear bumper should normally be observed in a captured image by a car-mounted camera, as a template image, and for determining that a deviation of an optical axis of the car-mounted camera occurs when a difference between a position of the rear bumper in the actually captured image by the car-mounted camera and a position of the rear bumper in the template image is more than a predetermined value. In addition, Patent Reference-1 discloses that, when the deviation of the optical axis occurs, a position of the camera is automatically adjusted by driving an actuator in accordance with a deviation amount.

### PRIOR ART REFERENCE

### Patent Reference

Patent Reference-1: Japanese Patent Application Laid-open under No. 2004-1658

### SUMMARY OF INVENTION

### Problem to Be Solved by the Invention

Conventionally, there is proposed a technique for installing a portable type terminal device such as a high-function portable telephone called “smartphone” in a vehicle by a holding device called “cradle”. Additionally, there is proposed a navigation called “AR navigation (AR: Augmented Reality)” which uses an actually captured image by a camera of the smartphone. The AR navigation displays an image for a route guide, such as a direction and a distance to a destination, in a manner superimposed on the actually captured image. Therefore, when the AR navigation is used, it is preferable that an image capturing direction of the camera coincides with a traveling direction of the vehicle.

However, there is a tendency that a user installs the cradle at an arbitrary position in the vehicle, and installs the smartphone in an arbitrary direction. Hence, in an initial installed condition, the image capturing direction of the camera tends not to coincide with the traveling direction of the vehicle. Therefore, after the above installation, it is preferable to perform an adjustment so that the image capturing direction of the camera coincides with the traveling direction of the vehicle.

Here, since the technique in Patent Reference-1 preliminarily prepares the template image for executing the process, it is difficult to apply the technique to the system having the smartphone and the cradle. This is because, since the user tends to install the cradle at the arbitrary position as mentioned above, it is difficult to preliminarily prepare a desired template image. Patent Reference-1 does not disclose a technique for assisting the user to manually adjust the image capturing direction.

The present invention has been achieved in order to solve the above problem. It is an object of the present invention to provide a terminal device, an image displaying method and an image displaying program executed by a terminal device, capable of easily adjusting an image capturing direction of a camera by a user, by displaying an appropriate adjustment image.

### Means for Solving the Problem

In the invention according to claim 1, a terminal device which is attachable to and removable from a holding device mounted on a movable body, includes: an image capturing unit; a storage unit which stores a captured image captured by the image capturing unit in such a state that the terminal device is attached to the holding device; an adjustment image generating unit which generates an adjustment image for adjusting an image capturing direction of the image capturing unit based on the captured image stored in the storage unit; and a display controlling unit which displays the adjustment image generated by the adjustment image generating unit in a manner mutually comparable to the captured image captured by the image capturing unit.

In the invention according to claim 14, an image displaying method executed by a terminal device which is attachable to and removable from a holding device mounted on a movable body, and which includes an image capturing unit, includes: a storage process which stores a captured image captured by the image capturing unit in such a state that the terminal device is attached to the holding device; an adjustment image generating process which generates an adjustment image for adjusting an image capturing direction of the image capturing unit based on the captured image stored in the storage process; and a display controlling process which displays the adjustment image generated by the adjustment image generating process in a manner mutually comparable to the captured image captured by the image capturing unit.

In the invention according to claim 15, an image displaying program executed by a terminal device which is attachable to and removable from a holding device mounted on a movable body, and which includes an image capturing unit and a computer, the program making the computer function as: a storage unit which stores a captured image captured by the image capturing unit in such a state that the terminal device is attached to the holding device; an adjustment image generating unit which generates an adjustment image for adjusting an image capturing direction of the image capturing unit based on the captured image stored in the storage unit; and a display controlling unit which displays the adjustment image generated by the adjustment image generating unit in a manner mutually comparable to the captured image captured by the image capturing unit.

### BRIEF DESCRIPTION OF THE DRAWINGS

FIGS. 1A to 1C illustrate a terminal device in a state held by a terminal holding device.

FIGS. 2A to 2D are diagrams illustrating rotated states of a terminal holder.

FIG. 3 illustrates a schematic configuration of a terminal device.

FIGS. 4A to 4C show an example of an adjustment image in a first example.

FIG. 5 shows an example of an adjustment screen in a first example.

FIGS. 6A to 6C show an example of an adjustment image and an adjustment screen in a second example.

FIG. 7 is a flow chart showing a main processing in a first embodiment.

FIG. 8 is a flow chart showing an adjustment screen display processing in a first embodiment.

FIG. 9 is a flow chart showing a main processing in a second embodiment.

### MODE TO EXERCISE THE INVENTION

According to one aspect of the present invention, there is provided a terminal device which is attachable to and removable from a holding device mounted on a movable body, including: an image capturing unit; a storage unit which stores a captured image captured by the image capturing unit in such a state that the terminal device is attached to the holding device; an adjustment image generating unit which generates an adjustment image for adjusting an image capturing direction of the image capturing unit based on the captured image stored in the storage unit; and a display controlling unit which displays the adjustment image generated by the adjustment image generating unit in a manner mutually comparable to the captured image captured by the image capturing unit.

The above terminal device is attachable to and removable from the holding device mounted on the movable body, and the image capturing unit such as a camera captures a landscape in front of the movable body, for example. The storage unit stores the captured image in such a state that the terminal device is attached to the holding device. The adjustment image generating unit generates the adjustment image for adjusting the image capturing direction of the image capturing unit based on the captured image stored in the storage unit. Namely, the adjustment image generating unit generates the adjustment image for assisting the user to adjust the image capturing direction. The display controlling unit displays the generated adjustment image in a manner mutually comparable to the actually captured image by the image capturing unit.

Once the adjustment of the image capturing direction is performed when the terminal device is attached to the holding device, the above terminal device displays the adjustment image generated by the captured image at the time of the said adjustment in a manner mutually comparable to the presently captured image, when the terminal device is next attached to the holding device. Therefore, by referring to a screen on which the adjustment image is displayed, the user can easily adjust the image capturing direction of the image capturing unit to a desired direction.

In one mode of the above terminal device, the adjustment image generating unit makes at least apart of the captured image stored in the storage unit translucent so as to generate the adjustment image.

In the mode, at least the part of the captured image is displayed by a watermarked picture. Therefore, the user can easily compare the actually captured image to the adjustment image, and can easily adjust the image capturing direction.

In another mode of the above terminal device, the adjustment image generating unit generates an image formed by a part of the captured image stored in the storage unit, as the adjustment image.

In the mode, the adjustment image generating unit generates an image indicating only a contour of the part of the captured image, as the adjustment image, for example. Therefore, the user can easily compare the actually captured image to the adjustment image, and can easily adjust the image capturing direction, too.

In still another mode of the above terminal device, the image capturing unit captures a range including apart of the movable body, and the adjustment image generating unit extracts an image corresponding to the part of the movable body from the captured image stored in the storage unit, and uses the extracted image as the part of the captured image.

In the mode, the adjustment image generating unit extracts an image corresponding to a part of the movable body in the captured image which does not change even if the landscape in front of the movable body captured by the image capturing unit changes by the traveling of the movable body, and generates the adjustment image based on the extracted image. By displaying the above adjustment image, it becomes possible to appropriately adjust the image capturing direction, even if the movable body moves from the time of removing the terminal device from the holding device to the time of attaching the terminal device to the holding device.

In still another mode of the above terminal device, the adjustment image generating unit uses an image in a predetermined range which is located in the lower part of the captured image stored in the storage unit, as the part of the captured image.

By displaying the above adjustment image, it becomes possible to appropriately adjust the image capturing direction, even if the movable body moves from the time of removing the terminal device from the holding device to the time of attaching the terminal device to the holding device, too. Additionally, according to the mode, since it is sufficient to extract the image in the predetermined range from the captured image, the adjustment image can be generated by easy processing.

In still another mode of the above terminal device, the adjustment image generating unit generates the adjustment image based on an image including at least a landscape in front of the movable body in the captured image stored in the storage unit, and, when a place where the terminal device is attached to the holding device substantially coincides with a place where the terminal device is removed from the holding device, the display controlling unit displays the adjustment image in a manner mutually comparable to the captured image.

In the mode, on the assumption that the landscape in front of the movable body which is captured by the image capturing unit hardly changes when the place where the terminal device is attached substantially coincides with the place where the terminal device is removed, the display controlling unit displays the adjustment image generated based on the image including at least the landscape in front of the movable body. Therefore, the user can easily adjust the image capturing direction, too. Additionally, according to the mode, the adjustment image can be generated by easy processing.

In still another mode of the above terminal device, when the terminal device is attached to the holding device, the display controlling unit displays the adjustment image in a manner mutually comparable to the captured image.

According to the mode, it becomes possible to mainly make the user adjust the image capturing direction at the time of the start of traveling. Namely, it becomes possible to prevent the user from adjusting the image capturing direction during the traveling and the stopping after the start of traveling.

Still another mode of the above terminal device further includes a route guiding unit which performs a route guide by using the captured image captured by the image capturing unit, and the storage unit sequentially stores the captured image captured by the image capturing unit during the route guide performed by the route guiding unit.

In the mode, on the assumption that the image capturing direction is appropriately adjusted when the route guide is performed, the storage unit sequentially stores the captured image at that time. Therefore, it becomes possible to appropriately generate the adjustment image based on the captured image in such a state that the image capturing direction is appropriately adjusted.

In a preferred example, when the route guide by the route guiding unit ends, the adjustment image generating unit generates the adjustment image based on the captured image stored in the storage unit. Preferably, when the terminal device is removed from the holding device, the adjustment image generating unit generates the adjustment image based on the captured image stored in the storage unit. By generating the adjustment image at that time, it is possible to appropriately generate the adjustment image based on the captured image in such a state that the image capturing direction is appropriately adjusted.

Still another mode of the above terminal device further includes: a route guiding unit which performs a route guide by using the captured image captured by the image capturing unit; and an obtaining unit which obtains a determination as to whether or not the adjustment image is generated, from a user, when the route guide by the route guiding unit ends, the obtaining unit obtains the determination as to whether or not the adjustment image is generated, from the user, when the obtaining unit obtains the determination indicating that the adjustment image is generated, from the user, the storage unit stores the captured image captured by the image capturing unit, and when the obtaining unit obtains the determination indicating that the adjustment image is generated, from the user, the adjustment image generating unit generates the adjustment image based on the captured image stored in the storage unit.

According to the mode, the user can determine whether or not to generate the adjustment image by user's will. Additionally, according to the mode, since the processing for sequentially storing the captured image is not executed, it becomes possible to reduce a processing load.

In still another mode of the above terminal device, the adjustment image generating unit generates a first adjustment image used for the adjustment when the terminal device is arranged vertically and a second adjustment image used for the adjustment when the terminal device is arranged laterally, and the display controlling unit displays the first adjustment image in a manner mutually comparable to the captured image when the terminal device is arranged vertically, and displays the second adjustment image in a manner mutually comparable to the captured image when the terminal device is arranged laterally.

According to the mode, as for both the case of arranging the terminal device vertically and the case of arranging the terminal device laterally, it is possible to generate the appropriate adjustment image, and to display the appropriate adjustment screen.

In still another mode, the terminal device is mounted on multiple movable bodies by the holding device, and further comprises an adjustment image storage unit which stores the adjustment image generated by the adjustment image generating unit for each of the multiple movable bodies, in relation to the multiple movable bodies, and the display controlling unit obtains the adjustment image corresponding to the movable body in the multiple movable bodies on which the terminal device is mounted, from the adjustment image storage unit, and displays the obtained adjustment image in a manner mutually comparable to the captured image.

According to the mode, even if the terminal device is used and mounted on the multiple movable bodies, it is possible to appropriately display the adjustment image in accordance with each movable body.

According to another aspect of the present invention, there is provided an image displaying method executed by a terminal device which is attachable to and removable from a holding device mounted on a movable body, and which includes an image capturing unit, including: a storage process which stores a captured image captured by the image capturing unit in such a state that the terminal device is attached to the holding device; an adjustment image generating process which generates an adjustment image for adjusting an image capturing direction of the image capturing unit based on the captured image stored in the storage process; and a display controlling process which displays the adjustment image generated by the adjustment image generating process in a manner mutually comparable to the captured image captured by the image capturing unit.

According to still another aspect of the present invention, there is provided an image displaying program executed by a terminal device which is attachable to and removable from a holding device mounted on a movable body, and which includes an image capturing unit and a computer, the program making the computer function as: a storage unit which stores a captured image captured by the image capturing unit in such a state that the terminal device is attached to the holding device; an adjustment image generating unit which generates an adjustment image for adjusting an image capturing direction of the image capturing unit based on the captured image stored in the storage unit; and a display controlling unit which displays the adjustment image generated by the adjustment image generating unit in a manner mutually comparable to the captured image captured by the image capturing unit.

Also by the image displaying method and the image displaying program described above, the user can easily adjust the image capturing direction by referring to the adjustment screen.

### Embodiment

The preferred embodiments of the present invention will now be described below with reference to the drawings.

[Device Configuration]

First, a configuration of a terminal device according to this embodiment will be described.

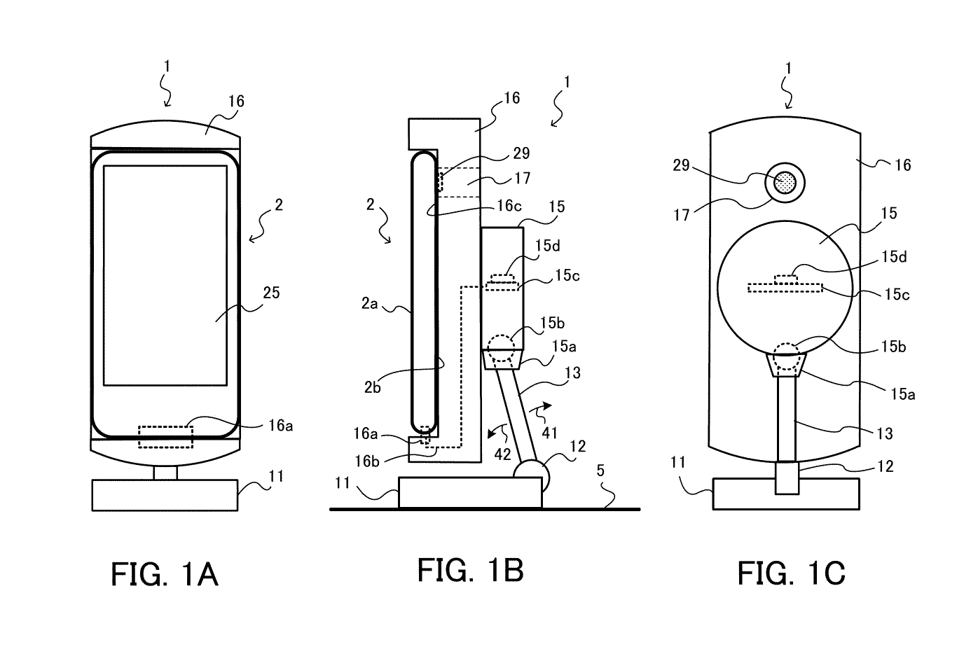

FIGS. 1A to 1C illustrate the terminal device 2 in such a state that it is held by a terminal holding device 1. FIG. 1A is a front view, FIG. 1B is a side view, and FIG. 1C is a rear view.

The terminal holding device 1 mainly includes a base 11, a hinge 12, an arm 13, a substrate holder 15 and a terminal holder 16. The terminal holding device 1 functions as a so-called cradle, to which the terminal device 2 such as a smartphone is attached.

The base 11 functions as a base used when the terminal holding device 1 is attached to a movable body such as a vehicle. For example, the base 11 is provided with a sucker or an adhesive tape at its underside, and the base 11 is fixed to an installation surface 5 such as a dashboard of the vehicle by the adhesive tape.

The hinge 12 is fixed to the arm 13, and is attached to the base 11 in a manner rotatable with respect to the base 11. By the rotation of the hinge 12, the arm 13 swings in a front-rear direction of the terminal device 2, i.e., in a direction of the arrows 41 and 42 in FIG. 1B. Namely, by rotating the arm 13 via the hinge 12 with respect to the base 11 fixed to the installation surface 5 of the vehicle, it is possible to adjust the installation angle of the substrate holder 15 and the terminal holder 16 with respect to the installation surface 5.

The substrate holder 15 includes a cover 15a, a ball link 15b, a sensor substrate 15c and a sensor 15d. The ball link 15b is attached to an upper end of the arm 13, and holds the substrate holder 15 at an arbitrary angle with respect to the arm 13. The cover 15a is provided at a lower end of the substrate holder 15, and has a function of restricting the rotation of the substrate holder 15 with respect to the arm 13. The sensor substrate 15c is provided inside of the substrate holder 15, and the sensor substrate 15c is provided with the sensor 15d.

The terminal holder 16 is a holder which holds the terminal device 2. The terminal holder 16 includes a connector 16a and a wiring 16b. The connector 16a is provided at the bottom of the front surface, i.e., the surface on which the terminal device 2 is set, and is connected to the connector of the terminal device 2 when the terminal device 2 is set to the terminal holder 16. The connector 16a is electrically connected to the sensor substrate 15c via the wiring 16b. Therefore, the detection signal of the sensor 15d is supplied to the terminal device 2 via the sensor substrate 15c, the wiring 16b and the connector 16a.

The terminal device 2 includes a front surface 2a, which is a front side of the body of the terminal device 2 and includes a display unit 25 such as an LCD panel, and a rear surface 2b which is a rear side of the body of the terminal device 2. Normally, the terminal device 2 is formed in a rectangular flat-plate shape, and the front surface 2a and the rear surface 2b are substantially parallel with each other.

The terminal holder 16 has a contact surface 16c at its front side. When the terminal device 2 is attached to the terminal holder 16, the contact surface 16c contacts and supports the rear surface 2b of the terminal device 2. In the example shown in FIGS. 1A and 1B, the contact surface 16c of the terminal holder 16 is formed such that its entire surface contacts the rear surface 2b of the terminal device 2. Instead, it is possible to employ such a configuration that one or plural parts of the contact surface 16c is formed to be partly protruding, and only the protruding parts contact the rear surface 2b of the terminal device 2.

On the rear surface 2b of the terminal device, a camera 29 is provided. Also, the terminal holder 16 of the terminal holding device 1 is formed with a hole 17 at the position confronting the camera 29 when the terminal device 2 is held by the terminal holding device 1. The hole 17 has a diameter larger than the diameter of the lens of the camera 29. Thus, in a state that the terminal device 2 is held by the terminal holder 1, the camera 29 is not suffered from the outer wall of the terminal holder 16 and can capture image behind the terminal holder 16. Specifically, the camera 29 captures image outside the vehicle.

In the example shown in FIGS. 1B and 1C, the terminal holder 16 is configured to cover substantially entire area of the rear surface 2b of the terminal device 2 and is formed with the hole 17 at the position confronting the camera 29 of the terminal device 2. Instead, the terminal holder 16 may be configured to cover only the area lower than the position of the camera 29 of the terminal device 2 when the terminal device 2 is held by the terminal holding device 1. In one example, the contact surface 16c of the terminal holder 16 may be formed into a shape extending to the position lower than the position at which the camera 29 of the terminal device 2 is provided (i.e., a shape in which the contact surface 16c does not exist above the position at which the camera 29 of the terminal device 2 is provided). In such an example, it is not necessary to form the hole 17 on the terminal holding device 1.

While the camera 29 is provided substantially on the center line in the left-right direction of the rear surface 2b of the terminal device 2, it is not limited that the camera 29 is provided at such a position. For example, the camera 29 may be provided at a position shifted, to some extent, from the center line in the left-right direction of the rear surface 2b. In this case, instead of forming the hole 17 on the terminal holder 16, a cutout may be formed at a part including the position of the camera 29 of the terminal device 2 when the terminal device 2 is held by the terminal holding device 1.

Next, the rotation function of the terminal holder 30 with respect to the substrate holder 20 will be described. The terminal holder 30 holding the terminal device 50 is rotatable, by the unit of 90 degrees, with respect to the substrate holder 20. Namely, when the state shown in FIG. 1A is defined as the rotation angle 0 degree, the terminal holder 30 can be fixed in four states being rotated by 0 degree, 90 degrees, 180 degrees and 270 degrees in a clockwise or counterclockwise direction. The reason why it can be fixed by the unit of 90 degrees is that a user normally uses the terminal device 50 in such a state that the display unit is arranged vertically or laterally, when the user sees the display unit. As described above, the terminal device 50 normally has a rectangular flat-plate shape. “Arranging vertically” means such an arrangement that the longitudinal direction of the display unit is vertical, and “arranging laterally” means such an arrangement that the longitudinal direction of the display unit is lateral.

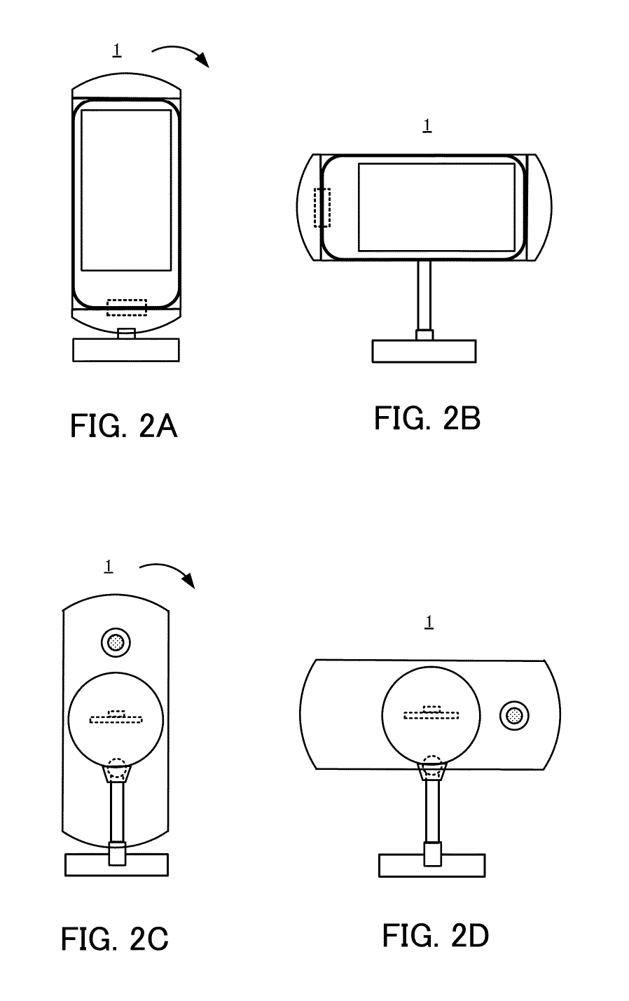

FIGS. 2A to 2D illustrate the states in which the terminal holder 30 is rotated. When the terminal holding device 1 is observed from the front side, rotating the terminal holder 30 by 90 degrees in the direction of the arrow from the state of FIG. 2A results in the state of FIG. 2B. When the terminal holding device is observed from the rear side, rotating the terminal holder 30 in the direction of the arrow from the state of FIG. 2C results in the state of FIG. 2D.

Structurally, by providing a rotational axis (not shown) at a substantial center of the substrate holder 20 and fixing the terminal holder 30 to the rotational axis, the terminal holder 30 becomes rotatable with respect to the substrate holder 20. Also, by providing pairs of concavity-convexity or recess-protrusion engage with each other at the positions of every 90-degree rotation angles, to the surface where the substrate holder 20 and the terminal holder 30 abut with each other, the terminal holder 30 can be fixed at the positions of every 90-degree rotation angles. The above-described structure is merely an example, and other structure may be employed as long as the terminal holder 30 can be fixed to the substrate holder 20 at every 90-degree rotation angles.

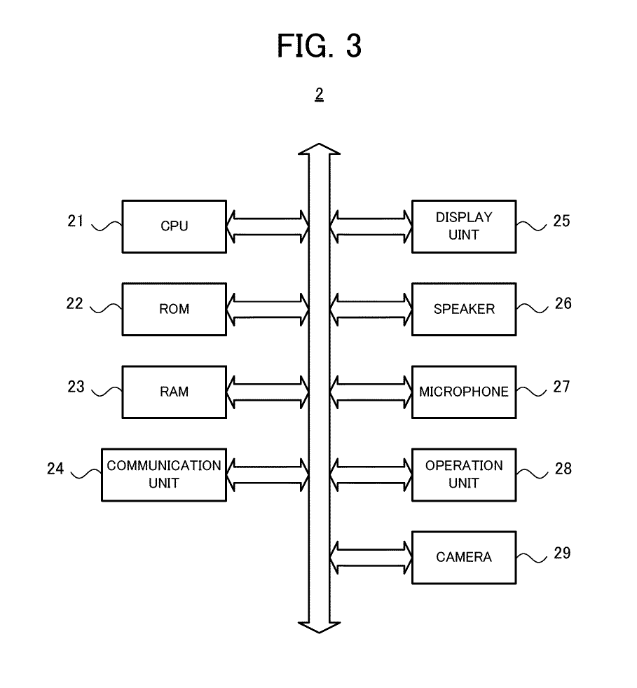

FIG. 3 schematically illustrates a configuration of the terminal device 2. As illustrated in FIG. 3, the terminal device 2 mainly includes a CPU 21, a ROM 22, a RAM 23, a communication unit 24, a display unit 25, a speaker 26, amicrophone 27, an operation unit 28 and the camera 29. The terminal device 2 is a portable-type terminal device such as a smartphone having a telephone call function. For example, the terminal device 2 is installed at a position on the dashboard where a driver of the vehicle can see the display unit 25, in a state held by the terminal holding device 1.

The CPU (Central Process Unit) 21 executes control of the terminal device 2 in its entirety. The ROM (Read Only Memory) 22 has a non-volatile memory, not shown, storing control program for controlling the terminal device 2. The RAM (Random Access

Memory) 23 stores data set by a user via the operation unit 26 in a readable manner, and provides a working area for the CPU 21.

The communication unit 24 is configured to be able to perform wireless communication with other terminal device 2 via a communication network. The display unit 25 may be a liquid crystal display, and displays characters and images to the user. The speaker 26 outputs sounds to the user. The microphone 27 collects voices spoken by the user.

The operation unit 28 may be operation buttons or a touch panel type input device provided on a casing of the terminal device 2, to which various selections and instructions by the user is inputted. If the display unit 25 is a touch panel type, the touch panel provided on the display screen of the display unit 25 may function as the operation unit 28.

The camera 29 may be a CCD camera, for example, and is provided on the rear surface 2b of the terminal device 2 as illustrated in FIGS. 1B and 1C. Basically, the direction of the optical axis (an axis extending vertically from the center of the lens) of the camera 29 coincides with the vertical direction of the rear surface of the terminal device 2 (i.e., the normal direction). The camera 29 may be provided, not only on the rear surface 2b of the terminal device 2, but also on the front surface 2a of the terminal device 2.

The camera 29 corresponds to an example of an image capturing unit of the present invention, the ROM 22 corresponds to an example of a storage unit of the present invention, and the CPU 21 corresponds to an example of an adjustment image generating unit, a display controlling unit, a route guiding unit, an obtaining unit and an adjustment image storage unit of the present invention (the detail will be described later).

[Method For Adjusting Image Capturing Direction]

Next, a description will be given of a method for adjusting the image capturing direction of the camera 29, in the embodiment.

At first, a brief description will be given of a reason for adjusting the image capturing direction. As described above, there is known the AR navigation which performs the route guide by using the captured image corresponding to the landscape in front of the vehicle which is captured by the camera 29 of the terminal device 2 in such a state that the terminal device 2 is mounted on the vehicle by the terminal holding device 1. The AR navigation displays the image for the route guide, such as the direction and the distance to the destination, in a manner superimposed on the captured image of the camera 29. Therefore, when the AR navigation is used, it is preferable that the image capturing direction of the camera 29 (specifically, an optical axis direction of the lens of the camera 29) coincides with the traveling direction of the vehicle. However, there is a tendency that the user installs the terminal holding device 1 at an arbitrary position in the vehicle, and installs the terminal device 2 in an arbitrary direction. Hence, in an initial installed condition, the image capturing direction of the camera 29 tends not to coincide with the traveling direction of the vehicle. Therefore, after the terminal device 2 is installed, it is preferable to perform an adjustment so that the image capturing direction of the camera 29 coincides with the traveling direction of the vehicle.

In consideration of the above problem, the embodiment assists the user to manually adjust the image capturing direction of the camera 29. Specifically, the embodiment displays an adjustment image for assisting the user to adjust the image capturing direction, on the display unit 25. More specifically, in the embodiment, the CPU 21 in the terminal device 2 generates the adjustment image based on the captured image of the camera 29 in such a state that the image capturing direction is appropriately adjusted. Then, in such a situation that the user adjusts the image capturing direction, the CPU 21 displays the adjustment image on the display unit 25 in a manner mutually comparable to the actually captured image, so as to assist the user to adjust the image capturing direction.

The “image capturing direction” of the camera 29 means the direction of the camera 29. Namely, the “image capturing direction” corresponds to the optical axis direction of the lens of the camera 29. Additionally, the “traveling direction” of the vehicle means the front-rear direction (specifically the front direction) of the vehicle.

More specifically, the CPU 21 generates the adjustment image based on the captured image which is displayed just before the terminal device 2 is removed from the terminal holding device 1 and/or the AR navigation ends, and stores the adjustment image in the ROM 22. When the terminal device 2 is attached to the terminal holding device 1 after that, the CPU 21 displays a screen (hereinafter referred to as “adjustment screen”) in which the stored adjustment image is superimposed on the captured image, on the display unit 25. By comparing the actually captured image of the camera 29 to the adjustment image, with reference to the adjustment screen, the user adjusts the image capturing direction of the camera 29 (i.e., the user adjusts the direction of the terminal device 2).

Thus, once the adjustment of the image capturing direction is performed when the terminal device 2 is attached to the terminal holding device 1, when the terminal device 2 is attached to the terminal holding device 1 next time, the CPU 21 displays the adjustment image which is generated by the captured image at the time of the said adjustment, in a manner superimposed on the presently captured image. Therefore, the user can easily adjust the image capturing direction of the camera 29 to the desired direction, by referring to the adjustment screen.

Hereinafter, a description will be given of examples of a generating method of the adjustment image in the embodiment. In the embodiment, the CPU 21 in the terminal device 2 stores the captured image of the camera 29 in such a state that the terminal device 2 is attached to the terminal holding device 1, in the ROM 22, and generates the adjustment image based on the stored captured image. In this case, the CPU 21 extracts a part of the stored captured image which becomes a guide for adjusting the image capturing direction, by image processing, and generates the adjustment image based on an image corresponding to the extracted part. For example, the CPU 21 extracts the part of the captured image which does not change even if the landscape in front of the vehicle captured by the camera 29 changes by the traveling of the vehicle. An example of the part of the captured image which does not change despite the change of the landscape in front of the vehicle is an image corresponding to a part of the vehicle, such as a bonnet, a bumper and an “A” pillar. Additionally, the CPU 21 executes the image processing such as a binarization processing, a contour extraction and a processing in accordance with a difference of multiple images, for example, so as to extract the above image from the captured image.

Here, a description will be given of a first example and a second example related to the generating method of the adjustment image.

In the first example, the CPU 21 makes at least the extracted part from the captured image translucent so as to generate the adjustment image. In other words, the CPU 21 converts the extracted part into “watermarked picture” so as to generate the adjustment image. Specifically, the CPU 21 makes the part of the captured image including at least the part of the vehicle translucent. Then, the CPU 21 displays the adjustment screen in which the above generated adjustment image is superimposed on the actually captured image of the camera 29, on the display unit 25.

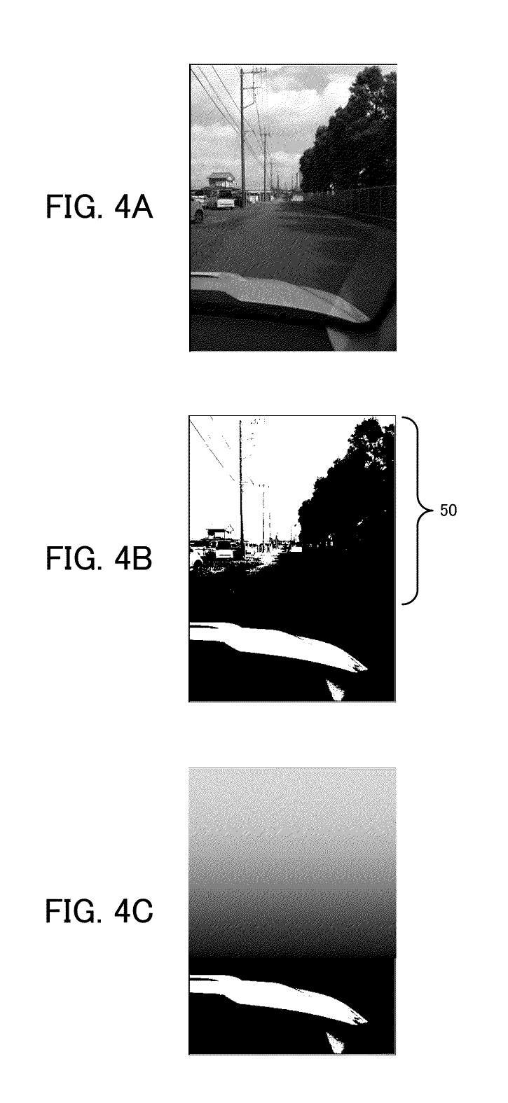

FIGS. 4A to 4C show an example of the adjustment image in the first example. FIG. 4A shows an example of the captured image by the camera 29. The captured image shows the image example of the landscape in front of the vehicle which is captured by the camera 29. The CPU 21 in the terminal device 2 executed the binarization processing of the captured image shown in FIG. 4A, so as to generate an image shown in FIG. 4B. Then, the CPU 21 masks an image 50 being located in the upper part of the image shown in FIG. 4B, by a gradation, so as to generate an image shown in FIG. 4C. Therefore, the image corresponding to the bonnet part of the vehicle is mainly extracted, and the other part is cleared. Then, the CPU 21 makes the image shown in FIG. 4C translucent, and uses the obtained image as the adjustment image.

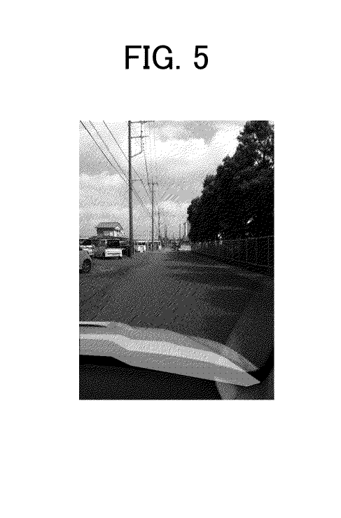

FIG. 5 shows an example of the adjustment screen in the first example. Specifically, FIG. 5 shows the adjustment screen in which the adjustment image generated by the method shown in FIGS. 4A to 4C is superimposed on the actually captured image of the camera 29. As shown in FIG. 5, in the adjustment screen, the actually captured image is visible through the translucent adjustment image. It is not limited that the adjustment image is displayed by an achromatic color. The adjustment image may be displayed by a predetermined chromatic color.

The user adjusts the image capturing direction of the camera 29 (i.e., the direction of the terminal device 2), by referring to the adjustment screen shown in FIG. 5. Specifically, the user adjusts the image capturing direction of the camera 29 so that a position of the image corresponding to the bonnet part in the actually captured image of the camera 29 coincides with a position of the image corresponding to the bonnet part in the adjustment image.

Next, in the second example, the CPU 21 generates an image formed by the extracted image from the captured image, as the adjustment image. Namely, the CPU 21 generates the adjustment image based on an image which is obtained by removing the image other than the extracted image from the captured image. Specifically, the CPU 21 generates an image indicating a contour of the part of the vehicle in the captured image, as the adjustment image. Then, the CPU 21 displays the adjustment screen in which the above generated adjustment image is superimposed on the actually captured image of the camera 29, on the display unit 25.

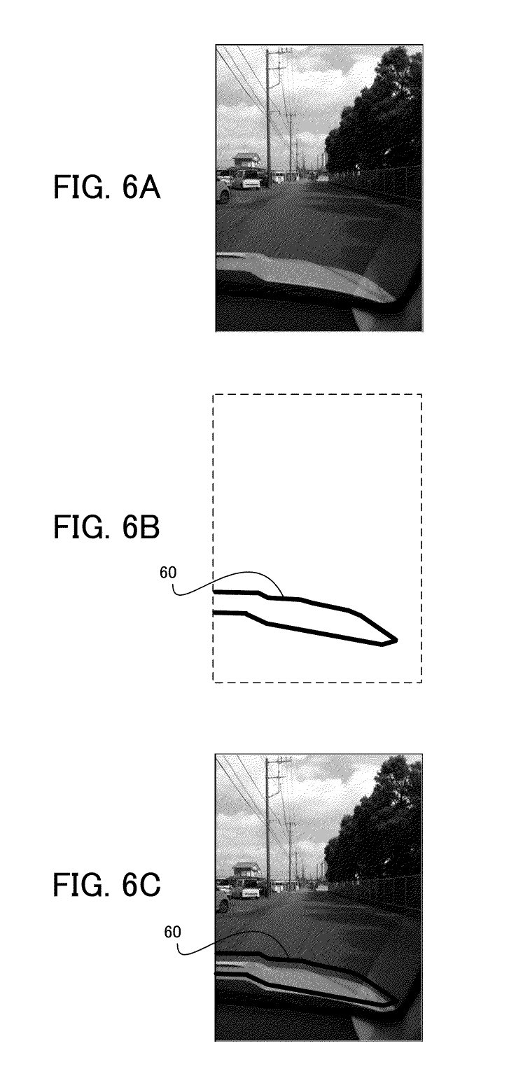

FIGS. 6A to 6C show an example of the adjustment image and the adjustment screen in the second example. FIG. 6A shows an example of the captured image similar to FIG. 4A. FIG. 6B shows an example of the adjustment image in the second example. The CPU 21 in the terminal device 2 executes the image processing for extracting the image corresponding to the part of the vehicle from the captured image shown in FIG. 6A, so as to generate the adjustment image shown in FIG. 6B. The adjustment image is only formed by an image 60 indicating the contour of the bonnet part of the vehicle. For example, the CPU 21 compares multiple captured images of the camera 29, and extracts a part in the multiple captured images which is not changed (i.e., removes a part which is changed), so as to generate the adjustment image.

FIG. 6C shows an example of the adjustment screen in the second example. Specifically, FIG. 6C shows the adjustment screen in which the adjustment image generated by the method shown in FIG. 6B is superimposed on the actually captured image of the camera 29. In the adjustment screen, the image 60 indicating the contour of the bonnet part of the vehicle is superimposed on the actually captured image. It is not limited that the image 60 is displayed by an achromatic color. The image 60 may be displayed by a predetermined chromatic color.

The user adjusts the image capturing direction of the camera 29 (i.e., the direction of the terminal device 2), by referring to the above adjustment screen. Specifically, the user adjusts the image capturing direction of the camera 29 so that a position of the image corresponding to the bonnet part in the actually captured image of the camera 29 coincides with a position corresponding to the bonnet part shown by the image 60 in the adjustment image.

By generating the adjustment image by the above illustrated method, it is possible to appropriately generate the adjustment image capable of efficiently assisting the user to adjust the image capturing direction. Additionally, by displaying the illustrated adjustment screen, the user can easily adjust the image capturing direction.

While the above examples show that the adjustment image is generated by extracting the image corresponding to the part of the vehicle from the captured image, it is not limited to use the above adjustment image. As another example, an image in a predetermined range which is located in the lower part of the captured image can be used as the adjustment image. This is because the lower part of the captured image tends to include the image corresponding to the part of the vehicle such as the bonnet, the bumper and the “A” pillar, which do not change even if the landscape in front of the vehicle changes. Namely, in the said example, on the assumption that the lower part of the captured image includes the image corresponding to the part of the vehicle, the CPU 21 uses the image in the predetermined range which is located in the lower part of the captured image, as the adjustment image, without executing the image processing for extracting the image corresponding to the part of the vehicle from the captured image. For example, a preliminarily set range in the captured image which includes at least the part of the vehicle can be used as “the predetermined range which is located in the lower part of the captured image”.

Additionally, when the above-mentioned another example is performed, the first example can be applied. Specifically, the CPU 21 makes the image in the predetermined range which is located in the lower part of the captured image translucent so as to generate the adjustment image.

[Flow According To First Embodiment]

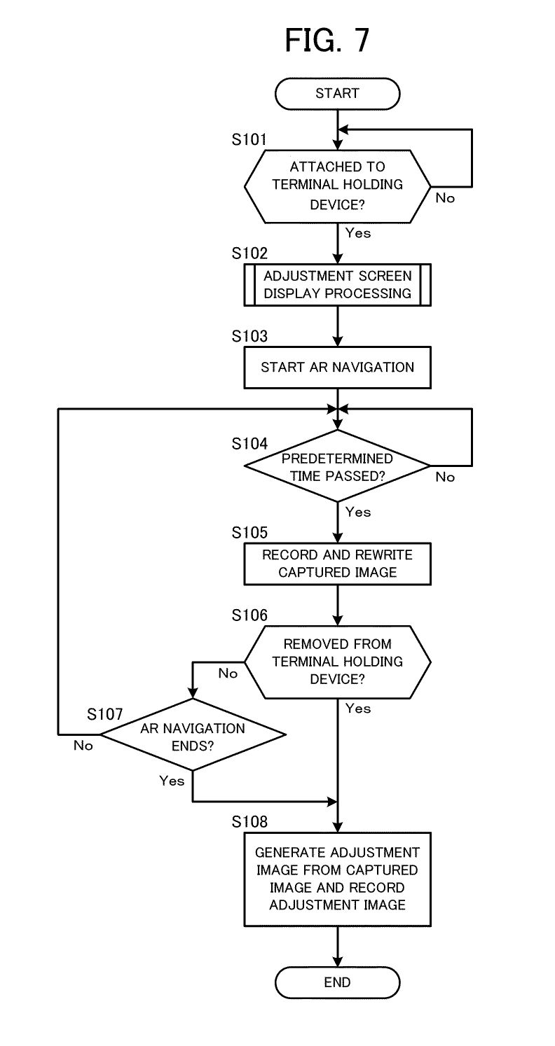

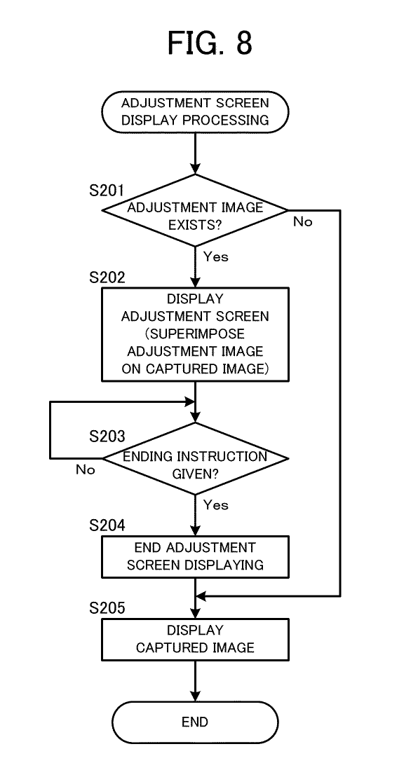

Next, a description will be given of a first embodiment. With reference to FIG. 7 and FIG. 8, a description will be given of a processing for generating the adjustment image and for displaying the adjustment screen in the first embodiment.

FIG. 7 is a flow chart showing a main processing in the first embodiment. In the said processing, when the terminal device 2 is attached to the terminal holding device 1, the CPU 21 executes a processing for displaying the adjustment screen. Additionally, when the terminal device 2 is removed from the terminal holding device 1 or the AR navigation ends, the CPU 21 executes a processing for generating the adjustment image based on the captured image which is displayed just before that. The said processing is realized by the CPU 21 in the terminal device 2, which executes the program stored in the ROM 22.

First, in step S101, the CPU 21 determines whether or not the terminal device 2 is attached to the terminal holding device 1. For example, the terminal holding device 1 is provided with a sensor which detects the attachment and the removal of the terminal device 2, and the CPU 21 obtains an output signal of the sensor so as to execute the determination in step S101. When the terminal device 2 is attached to the terminal holding device 1 (step S101: Yes), the processing goes to step S102. When the terminal device 2 is not attached to the terminal holding device 1 (step S101: No), the processing returns to step S101.

In step S102, the CPU 21 executes a processing for displaying the adjustment screen (Hereinafter, the processing is referred to as “adjustment screen display processing”. The detail of the adjustment screen display processing will be described later.). The reason for displaying the adjustment screen when the terminal device 2 is attached to the terminal holding device 1 is that the user is made to adjust the image capturing direction at the time of the start of traveling. In other words, the reason is that the user is prevented from adjusting the image capturing direction during the traveling and the stopping after the start of traveling. After step S102, the processing goes to step S103.

In step S103, the CPU 21 starts the AR navigation. Then, the processing goes to step S104. In step S104, the CPU 21 determines whether or not a predetermined time has passed since the captured image is stored last time. This determination is executed every predetermined time period in order to repeatedly store the captured image. When the predetermined time has passed (step S104: Yes), the processing goes to step S105. When the predetermined time has not passed (step S104: No), the processing returns to step S104.

In step S105, the CPU 21 stores the presently captured image of the camera 29 in the ROM 22. In this case, the CPU 21 rewrites the captured image stored last time by the captured image stored this time. Then, the processing goes to step S106.

In step S106, the CPU 21 determines whether or not the terminal device 2 is removed from the terminal holding device 1. Similar to step S101, this determination can be executed based on the output signal of the sensor provided in the terminal holding device 1, for example. When the terminal device 2 is removed from the terminal holding device 1 (step S106: Yes), the processing goes to step S108. When the terminal device 2 is not removed from the terminal holding device 1 (step S106: No), the processing goes to step S107.

In step S107, the CPU 21 determines whether or not the AR navigation ends. When the AR navigation ends (step S107: Yes), the processing goes to step S108. When the AR navigation does not end (step S107: No), the processing returns to step S104.

In step S108, the CPU 21 generates the adjustment image based on the captured image stored in step S105. Specifically, the CPU 21 generates the adjustment image based on the stored captured image by the above-mentioned method, and stores the generated adjustment image in the ROM 22. For example, the CPU 21 rewrites the adjustment image generated last time by the adjustment image generated this time.

Since the processing in step S108 is executed when the terminal device 2 is removed from the terminal holding device 1 or the AR navigation ends, the adjustment image is generated based on the captured image which is stored just before the terminal device 2 is removed or the AR navigation ends. In the first embodiment, on the assumption that the image capturing direction is appropriately adjusted when the terminal device 2 is removed or the AR navigation ends, the adjustment image is generated based on the captured image obtained at that time. After step S108, the processing ends.

FIG. 8 is a flow chart showing the adjustment screen display processing executed in step S102. The processing is realized by the CPU 21 in the terminal device 2, which executes the program stored in the ROM 22, too.

First, in step S201, the CPU 21 determines whether or not the adjustment image exists. Namely, the CPU 21 determines whether or not the adjustment image is stored in the ROM 22. When the adjustment image exists (step S201: Yes), the processing goes to step S202. When the adjustment image does not exist (step S201: No), the processing goes to step S205. In the latter case, since the adjustment image is not yet generated, the adjustment screen is not displayed.

In step S202, the CPU 21 displays the adjustment screen in which the adjustment image stored in the ROM 22 is superimposed on the captured image. Then, the user adjusts the image capturing direction by referring to the adjustment screen. Afterward, the processing goes to step S203.

In step S203, the CPU 21 determines whether or not an instruction for ending the display of the adjustment screen is given by the user. In this case, the CPU 21 obtains the instruction given by the user via the operation unit 28 and/or the microphone 27, so as to execute the determination. When the instruction for ending the display of the adjustment screen is given (step S203: Yes), the processing goes to step S204. When the instruction for ending the display of the adjustment screen is not given (step S203: No), the processing returns to step S203.

In step S204, the CPU 21 ends the display of the adjustment screen in accordance with the instruction by the user. Then, the processing goes to step S205. In step S205, the CPU 21 displays the captured image of the camera 29 on the display unit 25. Namely, the CPU 21 displays the captured image in order to execute the

AR navigation afterward. Then, the processing ends.

According to the above first embodiment, it is possible to appropriately generate the adjustment image for assisting the user to adjust the image capturing direction. Additionally, by displaying the adjustment screen on which the said adjustment image is superimposed, the use can easily adjust the image capturing direction.

If the terminal device 2 is powered off during the above execution of the AR navigation, when the terminal device 2 is powered on after that, the adjustment image may be generated based on the captured image which is stored just before the terminal device 2 is powered off.

[Flow According To Second Embodiment]

Next, a description will be given of a second embodiment. Specifically, a description will be given of a processing for generating the adjustment image in the second embodiment.

In the above first embodiment, when the terminal device 2 is removed from the terminal holding device 1 or the AR navigation ends, the CPU 21 generates the adjustment image. In the second embodiment, the CPU 21 inquires of the user whether or not to generate the adjustment image when the AR navigation ends, and generates the adjustment image when the user determines to generate the adjustment image. Specifically, while the CPU 21 in the first embodiment sequentially stores the captured image for generating the adjustment image until the terminal device 2 is removed from the terminal holding device 1 or the AR navigation ends, the CPU 21 in the second embodiment does not sequentially store the captured image. In the second embodiment, when the user determines to generate the adjustment image at the time of the end of the AR navigation, the CPU 21 stores the captured image for generating the adjustment image, and generates the adjustment image based on the said captured image.

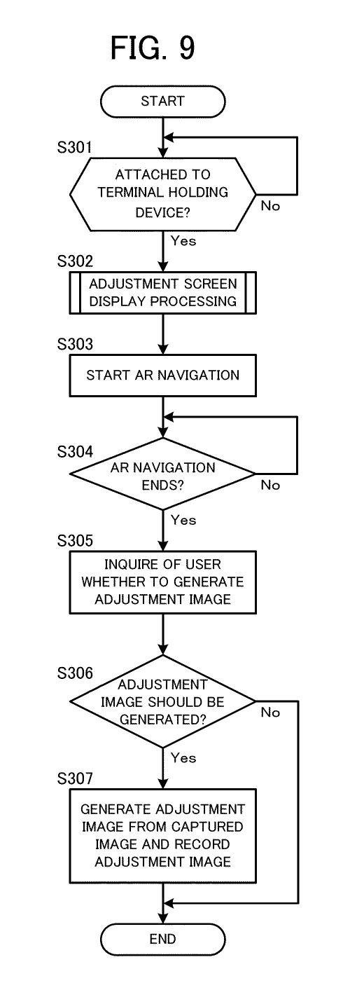

FIG. 9 is a flow chart showing a main processing in the second embodiment. The said processing is realized by the CPU 21 in the terminal device 2, which executes the program stored in the ROM 22.

Since the process in steps S301 to S303 are the same as the process in steps S101 to S103 shown in FIG. 7, description thereof will be omitted. Here, the process after step S304 will be described.

In step S304, the CPU 21 determines whether or not the AR navigation ends. When the AR navigation ends (step S304: Yes), the processing goes to step S305. When the AR navigation does not end (step S304: No), the processing returns to step S304.

In step S305, the CPU 21 inquires of the user whether or not to generate the adjustment image. For example, the CPU 21 displays information for inquiring of the user whether or not to generate the adjustment image, on the display unit 25, and/or outputs the information from the speaker 26. Then, the processing goes to step S306.

In step S306, the CPU 21 determines whether or not to obtain the determination for generating the adjustment image from the user, by the inquiry in step S305. In this case, the CPU 21 obtains the determination of the user via the operation unit 28 and/or the microphone 27, so as to execute the determination. When the determination for generating the adjustment image is obtained (step S306: Yes), the processing goes to step 5307. When the determination for generating the adjustment image is not obtained (step S306: No), the processing ends.

In step S307, the CPU 21 stores the presently captured image of the camera 29 in the ROM 22, and generates the adjustment image based on the stored captured image. In this case, the CPU 21 generates the adjustment image by the above-mentioned method, and stores the generated adjustment image in the ROM 22. For example, the CPU 21 rewrites the adjustment image generated last time by the adjustment image generated this time.

In the second embodiment, on the assumption that the image capturing direction is appropriately adjusted when the determination for generating the adjustment image is obtained from the user, the CPU 21 stores the captured image obtained at that time, and generates the adjustment image based on the said captured image. After step S307, the processing ends.

According to the above second embodiment, the user can determine whether or not to generate the adjustment image by user's will. Therefore, it is possible to appropriately suppress unnecessary storing of the captured image and unnecessary generation of the adjustment image in such a situation that the user can determines that the terminal device 2 is not appropriately installed, for example. Additionally, according to the second embodiment, since the processing for sequentially storing the captured image is not executed, it becomes possible to reduce a processing load compared to the first embodiment.

By the way, in the first embodiment, since the captured image is sequentially stored every predetermined time period during the execution of the AR navigation, it is possible to appropriately generate the adjustment image based on the stored captured image even if the terminal device 2 is removed from the terminal holding device 1 or the terminal device 2 is powered off.

### MODIFIED EXAMPLES

Next, a description will be given of modified examples.

### First Modified Example

In the above embodiment, the adjustment image is generated based on the image corresponding to the part of the captured image. Meanwhile, in a first modified example, the adjustment image is generated based on a substantially entire captured image. Specifically, in the first modified example, the CPU 21 generates the adjustment image based on the image including at least the landscape in front of the vehicle. For example, the CPU 21 makes the entire captured image translucent so as to generate the adjustment image.

As an example, only when a place where the terminal device 2 is attached to the terminal holding device 1 coincides with a place where the terminal device 2 is removed from the terminal holding device 1 before that, the CPU 21 can display the adjustment image according to the first modified example. This is because, since the landscape in front of the vehicle at the time of attaching the terminal device 2 is substantially the same as the landscape in front of the vehicle at the time of removing the terminal device 2 in such a case that the place where the terminal device 2 is attached coincides with the place where the terminal device 2 is removed before that (for example, the terminal device 2 is attached and removed in a parking lot), it is thought that it is possible to appropriately adjust the image capturing direction by using the adjustment image according to the above first modified example. For example, based on an electric wave received by a GPS receiver in the terminal device 2, the CPU 21 can determine whether or not the place where the terminal device 2 is attached coincides with the place where the terminal device 2 is removed.

As another example, the CPU 21 can display the adjustment image according to the first modified example when the place where the terminal device 2 is attached coincides with the place where the terminal device 2 is removed before that, and the CPU 21 can display the adjustment image which is generated based on the part of the captured image as shown in the above embodiment when the place where the terminal device 2 is attached doe not coincide with the place where the terminal device 2 is removed before that. Namely, the CPU 21 switches the displayed adjustment image in accordance with the two cases.

When the adjustment image according to the first modified example is displayed, the user can easily adjust the image capturing direction, too. Specifically, according to the first modified example, the user can easily adjust the image capturing direction when the place where the terminal device 2 is attached coincides with the place where the terminal device 2 is removed.

### Second Modified Example

In a second modified example, the adjustment image which is generated and stored when the terminal device 2 is arranged vertically is different from the adjustment image which is generated and stored when the terminal device 2 is arranged laterally. Specifically, the CPU 21 determines whether the terminal device 2 is arranged vertically or laterally, and separately stores the adjustment image (hereinafter referred to as “first adjustment image”) generated when the terminal device 2 is arranged vertically and the adjustment image (hereinafter referred to as “second adjustment image”) generated when the terminal device 2 is arranged laterally, in the ROM 22. Namely, as for both the first adjustment image and the second adjustment image, the latest images are separately stored.

Then, the CPU 21 determines whether the terminal device 2 is arranged vertically or laterally when the terminal device 2 is attached to the terminal holding device 1. When the terminal device 2 is arranged vertically, the CPU 21 reads and displays the first adjustment image. When the terminal device 2 is arranged laterally, the CPU 21 reads and displays the second adjustment image. For example, based on an output of a sensor which can detect an arrangement condition of the terminal device 2 and which is provided in the terminal device 2 or the terminal holding device 1, the CPU 21 determines whether the terminal device 2 is arranged vertically or laterally.

According to the second modified example, as for both the case of arranging the terminal device 2 vertically and the case of arranging the terminal device 2 laterally, it is possible to generate and store the appropriate adjustment image, and to display the appropriate adjustment screen.

### Third Modified Example

In a third modified example, the CPU 21 stores the adjustment image in relation to a type of the vehicle on which the terminal device 2 is mounted when the adjustment image is generated. Namely, the CPU 21 separately stores the adjustment images which are generated for multiple vehicles used by the user, in relation to the said multiple vehicles. Then, the CPU 21 reads the adjustment image corresponding to the vehicle in the multiple vehicles on which the terminal device 2 is presently mounted, from the ROM 22, and displays the read adjustment image. For example, the CPU 21 obtains the type of the vehicle and/or the vehicle information via a port for a diagnosis provided in the vehicle, so as to identify the vehicle on which the terminal device 2 is mounted.

According to the third modified example, even if the terminal device 2 is used and mounted on the multiple vehicles, it is possible to appropriately display the adjustment screen in accordance with each vehicle.

### Other Modified Examples

The above embodiments show such an example that the adjustment image is displayed in a manner superimposed on the captured image. However, as long as the adjustment image is displayed in a manner mutually comparable to the captured image, it is not limited that the adjustment image is displayed in a manner superimposed on the captured image. As another example, the adjustment image may be displayed side-by-side with the captured image.

The above embodiments show the image which is generated by making the part of the captured image or the entire captured image translucent, and show the image which is generated based on the contour of the image in the captured image, as examples of the adjustment image. However, as long as the captured image is processed in order to become the guide for the adjustment, it is not limited to these.

While the present invention is applied to a vehicle in the above description, the application of the present invention is not limited to this. The present invention may be applied to various movable bodies such as a ship, a helicopter and an airplane other than the vehicle.

As described above, the embodiment is not limited to the embodiment described above, and may be alterable as needed without contradicting the gist and the idea of the invention readable from claims and specification in its entirety.

### INDUSTRIAL APPLICABILITY

The present invention can be used in a cell phone having a telephone call function and a navigation apparatus performing route guide.

### DESCRIPTION OF REFERENCE NUMBERS

1 Terminal Holding Device
2 Terminal Device
15 Substrate Holder
16 Terminal Holder
21 CPU
25 Display Unit
28 Operation Unit
29 Camera

1. A terminal device which is attachable to and removable from a holding device mounted on a movable body, comprising:
an image capturing unit;
a storage unit which stores a captured image captured by the image capturing unit in such a state that the terminal device is attached to the holding device;
an adjustment image generating unit which generates an adjustment image for adjusting an image capturing direction of the image capturing unit based on the captured image stored in the storage unit; and
a display controlling unit which displays the adjustment image generated by the adjustment image generating unit in a manner mutually comparable to the captured image captured by the image capturing unit.

2. The terminal device according to claim 1,
wherein the adjustment image generating unit makes at least a part of the captured image stored in the storage unit translucent so as to generate the adjustment image.

3. The terminal device according to claim 1,
wherein the adjustment image generating unit generates an image formed by a part of the captured image stored in the storage unit, as the adjustment image.

4. The terminal device according to claim 2,
wherein the image capturing unit captures a range including a part of the movable body, and
wherein the adjustment image generating unit extracts an image corresponding to the part of the movable body from the captured image stored in the storage unit, and uses the extracted image as the part of the captured image.

5. The terminal device according to claim 2,
wherein the adjustment image generating unit uses an image in a predetermined range which is located in the lower part of the captured image stored in the storage unit, as the part of the captured image.

6. The terminal device according to claim 1,
wherein the adjustment image generating unit generates the adjustment image based on an image including at least a landscape in front of the movable body in the captured image stored in the storage unit, and
wherein, when a place where the terminal device is attached to the holding device substantially coincides with a place where the terminal device is removed from the holding device, the display controlling unit displays the adjustment image in a manner mutually comparable to the captured image.

7. The terminal device according to claim 1,
wherein, when the terminal device is attached to the holding device, the display controlling unit displays the adjustment image in a manner mutually comparable to the captured image.

8. The terminal device according to claim 1, further comprising a route guiding unit which performs a route guide by using the captured image captured by the image capturing unit,
wherein the storage unit sequentially stores the captured image captured by the image capturing unit during the route guide performed by the route guiding unit.

9. The terminal device according to claim 8,
wherein, when the route guide by the route guiding unit ends, the adjustment image generating unit generates the adjustment image based on the captured image stored in the storage unit.

10. The terminal device according to claim 8,
wherein, when the terminal device is removed from the holding device, the adjustment image generating unit generates the adjustment image based on the captured image stored in the storage unit.

11. The terminal device according to claim 1, further comprising:
a route guiding unit which performs a route guide by using the captured image captured by the image capturing unit; and
an obtaining unit which obtains a determination as to whether or not the adjustment image is generated, from a user,
wherein, when the route guide by the route guiding unit ends, the obtaining unit obtains the determination as to whether or not the adjustment image is generated, from the user,
wherein, when the obtaining unit obtains the determination indicating that the adjustment image is generated, from the user, the storage unit stores the captured image captured by the image capturing unit, and
wherein, when the obtaining unit obtains the determination indicating that the adjustment image is generated, from the user, the adjustment image generating unit generates the adjustment image based on the captured image stored in the storage unit.

12. The terminal device according to claim 1,
wherein the adjustment image generating unit generates a first adjustment image used for the adjustment when the terminal device is arranged vertically and a second adjustment image used for the adjustment when the terminal device is arranged laterally, and
wherein the display controlling unit displays the first adjustment image in a manner mutually comparable to the captured image when the terminal device is arranged vertically, and displays the second adjustment image in a manner mutually comparable to the captured image when the terminal device is arranged laterally.

13. The terminal device according to claim 1,
wherein the terminal device is mounted on multiple movable bodies by the holding device, and further comprises an adjustment image storage unit which stores the adjustment image generated by the adjustment image generating unit for each of the multiple movable bodies, in relation to the multiple movable bodies, and
wherein the display controlling unit obtains the adjustment image corresponding to the movable body in the multiple movable bodies on which the terminal device is mounted, from the adjustment image storage unit, and displays the obtained adjustment image in a manner mutually comparable to the captured image.

14. An image displaying method executed by a terminal device which is attachable to and removable from a holding device mounted on a movable body, and which includes an image capturing unit, comprising:
a storage process which stores a captured image captured by the image capturing unit in such a state that the terminal device is attached to the holding device;
an adjustment image generating process which generates an adjustment image for adjusting an image capturing direction of the image capturing unit based on the captured image stored in the storage process; and
a display controlling process which displays the adjustment image generated by the adjustment image generating process in a manner mutually comparable to the captured image captured by the image capturing unit.

15. An image displaying computer program product stored in a non-transient tangible computer-readable medium and executed by a terminal device which is attachable to and removable from a holding device mounted on a movable body, and which includes an image capturing unit and a computer, the computer program product makes the computer function as:
a storage unit which stores a captured image captured by the image capturing unit in such a state that the terminal device is attached to the holding device;
an adjustment image generating unit which generates an adjustment image for adjusting an image capturing direction of the image capturing unit based on the captured image stored in the storage unit; and
a display controlling unit which displays the adjustment image generated by the adjustment image generating unit in a manner mutually comparable to the captured image captured by the image capturing unit.

16. A terminal device which is attachable to and removable from a movable body, comprising:
an image capturing unit;
an adjustment image generating unit which generates an adjustment image for adjusting an image capturing direction of the image capturing unit based on a captured image captured by the image capturing unit in such a state that the terminal device is attached to the movable body; and
a display controlling unit which displays the adjustment image in a manner mutually comparable to the captured image captured by the image capturing unit.

17. The terminal device according to claim 3,
wherein the image capturing unit captures a range including a part of the movable body, and
wherein the adjustment image generating unit extracts an image corresponding to the part of the movable body from the captured image stored in the storage unit, and uses the extracted image as the part of the captured image.

18. The terminal device according to claim 3,
wherein the adjustment image generating unit uses an image in a predetermined range which is located in the lower part of the captured image stored in the storage unit, as the part of the captured image.
